(19) United States
(12) Patent Application Publication
(10) Pub. No.: US 2007/0263661 A1
(43) Pub. Date: Nov. 15, 2007

(54) WIDE AREA MULTI-SERVICE COMMUNICATION NETWORKS BASED ON CONNECTION-ORIENTED PACKET SWITCHING

(76) Inventor: Kevin DeMartino, Orleans, MA (US)

Correspondence Address: HOLLAND & HART, LLP, P.O BOX 8749, DENVER, CO, 80201, US

(21) Appl. No.: 11/747,520

(22) Filed: May 11, 2007

Related U.S. Application Data
(60) Provisional application No. 60/799,701, filed on May 11, 2006.

(51) Int. Cl. H04J 3/24; H04L 12/66

(52) U.S. Cl. 370/474; 370/352

(57) ABSTRACT

Packet switching techniques that provide a quality of service comparable to a quality of service associated with circuit switching are disclosed. Internet Protocol (IP) packets are transported through a network based on labels attached to the packets. Control and signaling protocols set up virtual connections through the network and allocate network capacity to particular virtual connections. Packets are forwarded through the network along label switched paths in accordance with Multi-Protocol Label Switching standards. In an embodiment, IP headers may be removed as packets enter the network and re-inserted as packets exit the network. This removal enhances security by reducing vulnerabilities associated with transport based on IP. Network and label switching elements may be configured to operate simultaneously in both circuit switching and packet switching modes. Label switching elements may be configured as conventional routers to accommodate unlabeled packets. In various embodiments, the network may be compatible with legacy networks and equipment.

### REFERENCE TO PREVIOUS PATENT APPLICATION

This application claims the benefit under 35 U.S.C. 119 (e) of U.S. Provisional Patent Application No. 60/799,701, filed May 11, 2006 by Kevin A. DeMartino for “Equivalence of Fast Circuit Switching and Connection-Oriented Packet Switching,” which patent application is hereby incorporated herein by reference.

### FIELD OF THE INVENTION

The invention relates to communication networking. More specifically, it relates to multi-service networks and with methods for transporting data through communication networks.

### BACKGROUND OF THE INVENTION

### The Goal of an Integrated Communications Network

In the past, a communications network was typically designed to provide a specific communication service. Networks designed around a specific service include telephone networks, cable television, and the Internet. Telephone networks were designed to support voice over circuit switched connections. Cable television networks were designed to provide broadcast video. The Internet was designed to support computer communications using packet switching. Subscribers needed to access multiple networks in order to obtain a full range of communication services.

It is desirable to have a common, integrated network that can provide each subscriber with a full range of communication services over a single broadband access line. The capacity provided to each subscriber should be sufficient to accommodate full motion video among other high data rate communication functions. High speed network access can be provided over twisted pair telephone lines using digital subscriber line (DSL) techniques or over TV cable using hybrid fiber-coax (HFC) techniques. With these approaches, integrated services can be supported. However, the supporting networks are not fully integrated with one another. The various networks, including DSL and HFC access networks, circuit-switching voice networks, broadcast video networks, and packet-switching Internet, interface with each other. However, these networks maintain distinct identities.

The integration of network services is difficult in that some services, such as voice, were based on circuit switching, while other services, such as file transfers, were based on packet switching. An integrated network may be based on circuit switching or packet switching. These networking techniques are described below.

### Circuit Switching Networks

Circuit switching techniques have been employed by telephone networks for over 100 years. Circuit switching networks establish end-to-end physical layer connections through the network. Transmission resources, specifically channels through the network, are dedicated to a particular connection for the duration of a call. With circuit switching, delays are minimized and fixed. A stream of data can be transported through a circuit switching network without suffering any distortion. Also, the processing performed by a circuit switching network is relatively simple and straightforward. On the other hand, the utilization of dedicated channels can be low if there is a significant variation in the data rate. Consequently, circuit switching networks are usually inefficient for transporting bursty data.

To cause a connection to be set up or released, a subscriber must signal the network. Similarly, control signals must be transmitted within the network to cause channels to be assigned to a particular connection. Control signals may be associated with a particular data channel and transmitted in the channel along with the data. Alternately, a common signaling channel can be used to control multiple data channels. Channel-associated signaling is employed when a subscriber dials the telephone to provide the network with the information, e.g., the telephone number, it needs to establish a connection. In this case, signaling information is sent from the subscriber to the network in the same band or channel used for voice transmission. Within telephone networks, control information is usually transferred between nodes over a common signaling channel using the Signaling System Number 7 (SS7) set of protocols. Network control signals may follow different paths than the data they are controlling.

With the advent of Integrated Services Digital Networks, common channel signaling was extended to the user-to-network interface (UNI). ISDN provides the user with a separate signaling channel, the D channel, which is used to control the assignment of data transfer channels (B channels) to a particular connection. Using the D channel signaling, the subscriber can request that the network allocate additional B channels to an active connection. Unfortunately, most narrowband ISDN interfaces provide only two B channels to a subscriber, which greatly limits the utility of narrowband ISDN.

Data is usually transferred digitally through circuit switching networks. With the telephone networks, analog data is usually converted to digital form at the local central office (CO). In the case of ISDN, and other digital lines, data is already in digital form at the subscriber interface.

Delays through circuit switching networks are minimal and fixed. There may be some small buffering delays, but except for the case of local traffic, these buffering delays are usually small compared to unavoidable propagation delays. If the bit error rate is low, which is normally the case, then data would be transported through a circuit switching network without distortion. In this case, the data stream exiting the network would be identical to the data stream entering the network except for a small fixed delay. This property of circuit switching networks is important for continuous data streams, such as those produced by voice and video sources, which can be adversely affected by variable delays.

Quality of service, also referred to as QoS, measures include data rates, delays, delay variations, and error rates. A circuit switching network can provide a guaranteed QoS with a fixed data rate, a low fixed delay, and without errors due to lost or out of order data. These characteristics make circuit switching operation compatible with legacy networks and most data sources.

Compared to packet switching, circuit switching is relatively simple and straightforward to implement. Circuit switched channels, such as Synchronous Optical Network (SONET) or Synchronous Digital Hierarchy (SDH) channels, can be readily aggregated, which makes circuit switching networks scalable. If the data rates are high enough, it is practical to implement circuit switching with optical components. This is currently not an option for packet switching.

The primary disadvantage of circuit switching is inefficiency for transporting bursty data. Channels with sufficient capacity to handle the required peak data rate for a particular connection must be dedicated to that connection. If the data rate is bursty, i.e., the peak data rate is much greater than the average data rate, then the channels assigned to a connection will be under-utilized most of the time. This is particularly true for human initiated file transfers, which tend to be very intermittent, and where the utilization may be a few percent or less. For applications involving continuous data flows, such as voice or streaming audio/video, the percentage variation in the data rate is much less than the percentage variation for file transfers. Consequently, circuit switching is much more efficient for continuous data sources than it is for intermittent sources.

### Packet Switching Networks

Packet switching operation involves breaking up data blocks into smaller blocks, or packets, which contain header and trailers in addition to the data. Packets are switched through the network based on information provided in the packet headers. With packet switching, transmission resources, i.e., channels, are dynamically shared by multiple data sources rather than being dedicated to a single source. This makes packet switching more efficient than circuit switching for transporting bursty data.

The Internet can be viewed as a large number of packet switching networks interconnected by routers. These routers use the Internet Protocol, referred to as IP, as a common protocol for transferring packets through the Internet. Within the subnets that constitute the Internet, a diverse set of protocols are used for transferring packets. These protocols may include, but are not limited to, X.25, Frame Relay, Ethernet, or the Asynchronous Transfer Mode (ATM) protocol.

The Internet is highly dependent on the telephone networks and on the circuit switched connections provided by the telephone networks. Typically, Internet clients and servers are connected to the Internet through the telephone networks, and the Internet can be viewed as being overlaid on the telephone networks. Access to the Internet may involve either circuit switched connections or packet switched connections with Internet service providers, referred to as ISPs. The IP router at an ISP's point of presence, i.e., PoP, may be considered to be the point of entry to the Internet. Within the Internet, routers are usually connected to each other by leased lines contained within trunks.

The primary rationale for packet switching networks in general, and the Internet in particular, is that dedicated end-to-end connections between clients and servers are not required. For the most part, physical connections may be shared rather than dedicated. Physical connections from a client to the Internet, e.g., ISP and PoP, which typically covers a distance of several miles, may usually be dedicated to the flow of data between a single client and a single server. Physical connections through the Internet, which may cover a distance of thousands of miles, may be shared by many client/server data flows. For most servers, the physical connection between the server and the Internet may be shared by multiple data flows. Thus, packet switching provides more efficient utilization of the existing telephone infrastructure without changing it.

The Internet generally utilizes a suite of communication protocols referred to as Transmission Control Protocol/Internet Protocol, i.e., TCP/IP. The TCP/IP approach to packet switching offers some particular advantages compared to alternative packet switching approaches. IP is a connectionless protocol with globally significant addresses contained in the header of IP packets. This generally means that IP packets may be treated independently of each other. Much of the TCP/IP functionality, such as packet sequencing, flow control, and error control, has been assigned to TCP. With TCP, end-to-end virtual connections, which set parameters for transferring data without assigning physical network channels, are established between subscribers. With this type of operation, TCP is implemented in the end stations, but not seen by the network itself This allocation of functions simplifies processing within the network and facilitates interfacing between heterogeneous networks. The widespread acceptance of TCP/IP, compared to other packet switching protocols, such as X.25, and the success of the Internet can attributed in part to such operation.

The global addresses in the IP header provide the information required to route packets through the Internet. The term “routing” usually refers to determining the route that a packet should follow in traversing the network. The term “forwarding” refers to moving a packet from a particular input port of the router (or more generally, the packet switch) to a particular output port. Forwarding requires processing of information in the packet header, which is linked to data in the packet payload. This linking is analogous to channel-associated signaling in circuit switching networks.

Problems associated with packet switching networks stem largely from the fact that packet switching causes an inevitable distortion of the stream of data flowing from a data source. With packet switching, data from a source is broken up into packets and headers and trailers are attached to these packets. Of course, the data can be reassembled to its original form at the receiving end if uncorrectable errors are not introduced in the transmission process. Consequently, for data transfers that are not time sensitive, such as most file transfers, en route distortions associated with packet switching are not usually a problem. However, for continuous data sources, such as voice or streaming audio/video sources, distortions introduced by packet switching can be problematic. If the random delay variations are too large, then the data may arrive too late to be used by a time sensitive application or too much data may arrive too early to be accommodated by a finite buffer.

Even if the bit error rate is close to zero, the distortions of the data stream described above can produce errors in the received data. Specifically, these errors are the result of lost or out of order packets, discarded late packets, and buffer overflows. For time insensitive applications, these errors can be corrected by the error control features of higher layer protocols, such as TCP. However, these errors can adversely affect time sensitive applications, particularly those applications associated with continuous data sources.

In packet switching networks forwarding decisions must be made on-the-fly. This makes the processing required for packet switching more complex and demanding than the corresponding processing for circuit switching.

In addition to the generic packet switching problems described above, there are problems specifically related to the TCP/IP approach. TCP is implemented in the end stations and is not seen by the network. This means that functions that strongly impact network performance, such as virtual connection establishment (and release) and flow control, are outside the control of the network. IP, which is a connectionless protocol and has very limited functionality, is the operative protocol for network elements, specifically network routers. Because of the limitations of IP, it is difficult for a network relying solely on IP to control congestion and to provide a guaranteed quality of service. Also there are security issues associated with the use of global IP addresses.

### Integrated Networks Based on Connection-Oriented Packet Switching

Currently, most data that is transported through the wide area networks is carried in IP packets. Voice over IP is becoming widely accepted. Now video over IP is gaining acceptance. Eventually, it appears that almost all application data will be encapsulated in IP packets. Thus, it makes sense that an integrated network should be based on IP data.

With IP-based transport, routing (i.e., forwarding) of packets is based on the destination address in the IP header. Since IP is a connectionless protocol, packets in a data stream can be forwarded independently of each other. Connectionless protocols simplify network operation and are suitable for applications, such as file transfers, that do not require a guaranteed quality of service. However, connectionless protocols are not particularly suitable for continuous data streams or for time-sensitive applications, such as voice. By itself, IP-based transport is cannot match the quality of services that can be provided with connection-oriented transport and does not provide a firm foundation for an integrated network.

Label switching, which may also be referred to as tag switching, is a technique that can be used to incorporate connection-oriented features into IP networks and other types of networks. With label switching, virtual connections are established and packets are forwarded through the network based on labels rather than on the complete destination address. Multi-Protocol Label Switching (MPLS) provides a means for establishing virtual connections, which are called label switched paths (LSPs), through the exchange of control messages among network elements. LSPs are established through the network, and IP packets are switched (forwarded) along these LSPs. Network capacity can be reserved along the LSPs so that the quality of service for a traffic flow can be guaranteed.

The Label Distribution Protocol (LDP) and/or the Resource Reservation Protocol (RSVP) are employed in conjunction with MPLS to establish LSPs and reserve network capacity along these LSPs. The Internet Engineering Task Force (IETF) is developing a new extensible signaling protocol suite (NSIS) that will provide additional capabilities and more flexibility in establishing and controlling virtual connections.

To be compatible with legacy equipment and networks, label switching elements must handle unlabeled packets. Thus, in addition to forwarding packets based on labels, network switches must operate as conventional IP routers and forward packets based on their IP addresses.

### Integrated Networks Based on Fast Circuit Switching

The Internet Engineering Task Force (IETF) is developing network control and signaling standards based on MPLS that apply to both circuit switching and packet switching. Generalized MPLS (GMPLS) provides for implicit labels, which can be used to associate a data flow with a particular channel. With GMPLS, the control signaling is separated from the data transport so that control signals and data are in different channels and can be processed separately. This type of operation is similar to common channel signaling approach used in conjunction with narrowband ISDN. One option for GMPLS is to use RSVP with traffic engineering extensions (RSVP-TE) as the label distribution protocol.

U.S. Pat. No. 7,149,210 relates to an architecture for an integrated services network based on dynamic switching of the channels assigned to connections through the network. This network combines the advantages of circuit switching and packet switching. Channels are quickly assigned to a connection to support a particular data flow and quickly released when they are no longer needed. Network control and signaling are based on a logical extension of the GMPLS concept. As such, bursty data can be efficiently supported while continuous data streams are transported through the network without distortion.

U.S. Pat. No. 7,149,210 relates to a common switching element that may perform both circuit switching and packet switching functions. More specifically, these elements can support fast circuit switching and connection-oriented packet switching. A wide area network may include a large number of these common switching elements, fiber optic transmission lines interconnecting these elements, and access lines connecting clients and servers to the network.

U.S. Pat. No. 7,149,210 relates to the fast circuit switching mode of operation, which is referred to as “dynamic channel switching.” With this dynamic channel switching approach, control signals are separated from the data and transported in common control channels in advance of the data they control. Control and signaling operation can be viewed as a logical extension of generalized multi-protocol label switching (GMPLS) operation. A variable number of data channels are dynamically assigned to each connection through the network. Channels are quickly switched in to accommodate the data flow through a connection and switched out when they are no longer needed. With this approach, a continuous data stream is not altered as it transverses the network and data channels are efficiently utilized even if the data source is bursty.

U.S. Pat. No. 7,149,210 is based on a fast circuit switching approach and may be a departure from the current direction of the telecommunications industry. This departure raises compatibility issues and suggests that alternative implementations may be desirable for integrated networks, at least for the near term.

### SUMMARY OF THE INVENTION

Fast circuit switching may achieve the resource utilization efficiency normally associated with packet switching, and connection-oriented packet switching may provide a quality of service normally associated with circuit switching. U.S. Pat. No. 7,149,210 addresses fast circuit switching operation, which is referred to as “dynamic channel switching.” Described herein is connection-oriented packet switching. More specifically, various embodiments relate to label switching of IP packets. Dynamic channel switching and connection-oriented packet switching represent two complementary approaches for transporting data through wide area networks. The fast circuit switching approach may provide more efficient transport. However, the connection-oriented packet switching approach is more compatible with legacy networks and equipment.

Like the network and network elements of U.S. Pat. No. 7,149,210, the network and label switching elements described herein may accommodate both circuit switching and packet switching modes of operation. For both the embodiments of networks described herein and the network of U.S. Pat. No. 7,149,210, control signals are employed to dynamically set up virtual connections and dynamically allocate network capacity for these connections. However, there are significant differences between the various embodiments of the present invention and those of U.S. Pat. No. 7,149,210.

In the packet switching mode of operation, labels may be attached to IP packets, and these labels may be used to forward packets through the network. Control and signaling protocols may be used to set up virtual connections through the network and to allocate network resources to particular virtual connections. Packets may be forwarded through the network along label switched paths, which are virtual connections in accordance with Multi-Protocol Label Switching (MPLS) standards. Network capacity may be dynamically allocated to particular label switched paths and varied based on need.

To support a guaranteed quality of service for a particular data flow, network capacity sufficient to accommodate the data flow may be allocated to a particular virtual connection for a certain period of time. Allocations may be made in advance of need and may be dynamically varied to accommodate the needs of particular data flows. This may ensure that sufficient capacity is provided to accommodate particular data flows so as to keep delays through the network below a specified value. From a quality of service perspective, the transport method of embodiments may be equivalent to transport based on circuit switching. Providing a guaranteed quality of service for particular data flows as described herein below is not disclosed in the prior art.

Exemplary embodiments disclose a network for forwarding of packets based on labels rather than global IP addresses. Security may be enhanced by suppressing the IP headers as packets enter the network and re-inserting the headers as the packet leave the network. This reduces overhead and prevents the exploitation of global addresses by certain type of threats. Re-insertion of the IP headers as the packets leave the network allows the network to maintain compatibility with user equipment and with legacy networks. The suppression of IP headers to achieve greater transport efficiency and enhanced security is not disclosed in the prior art.

### BRIEF DESCRIPTION OF THE DRAWING

FIG. 1 shows the nodes and links of a simple communication network.

FIG. 2 illustrates the interconnections of switching elements in the network of FIG. 1 to form a packet switching network.

FIG. 3 shows an embodiment of the elements involved with the connection-oriented packet switching mode of operation.

FIG. 4 shows an embodiment of the protocols involved in the transfer of data through the network.

FIG. 5 shows a generic switching element that can operate in both circuit switching and packet switching modes.

FIG. 6 illustrates the mapping of data form the input channels to the output channels of the switching element of FIG. 5.

FIG. 7 is a diagram of a simple packet switching network.

FIG. 8 illustrates how reserving of network capacity minimizes the delay through the network.

FIG. 9 illustrates the removal and re-insertion of IP headers as packets enter and leave the network, respectively.

### DETAILED DESCRIPTION

### Equivalence of Connection-Oriented Packet Switching with Circuit Switching

A virtual connection is an agreement to transfer data between two or more entities according to certain procedures. With connection-oriented packet switching, virtual connections are established for particular traffic flows prior to transferring data. Establishing a virtual connection usually entails setting up the route along which the traffic will flow and establishing parameters, such as virtual connection identifiers, along this route.

The equivalence of connection-oriented packet switching may be equivalent with circuit switching in the sense that connection-oriented packet switching may provide a quality of service that is comparable to the quality of services provided by circuit switching. Fast circuit switching and connection-oriented packet switching may be implemented in the same network using common network elements. U.S. Pat. No. 7,149,210 discloses network operation based on fast circuit switching. Network operation based on connection-oriented packet switching is discussed herein.

There are a number of conditions that need to be met for connection-oriented packet switching to be comparable or generally equivalent to circuit switching. These conditions depend on the specific application. The key condition is that delays though the packet switching network must not significantly impact the application.

### Network Providing the Basis for Integrated Services

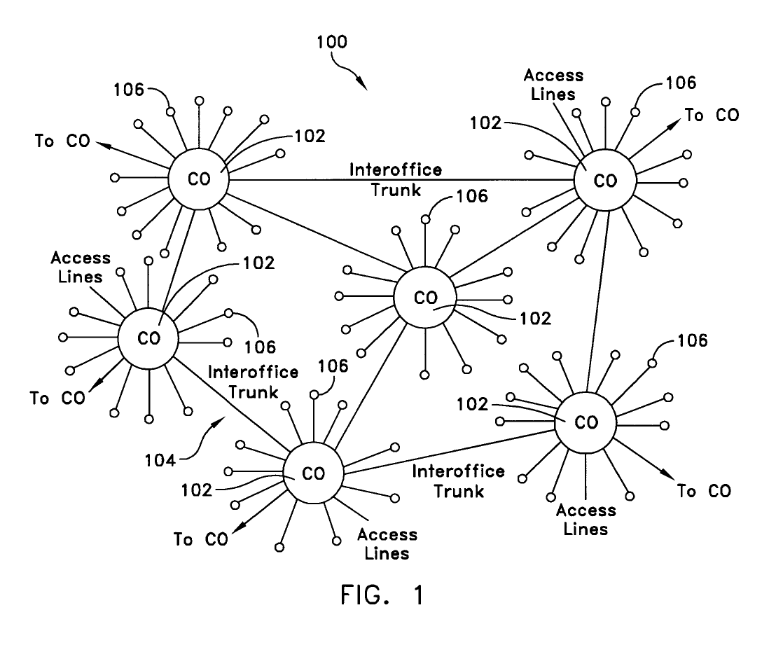

A typical communications network may comprise access networks, which connect users to network nodes, and a backbone network interconnecting the nodes. In the case of telephone networks, the network nodes are referred to as central offices, or COs, and the backbone network is referred to as the interoffice network. Referring to FIG. 1, there is shown a simplified landline telephone network 100 with a number of COs 102 interconnected in a mesh configuration 104. Each CO 102 is connected to many subscribers 106 and is directly connected to two or more other Cos 102. COs 102 are fully interconnected through mesh 104. In an embodiment, network 100, shown in FIG. 1, may serve as the basis for an integrated network. More specifically, network 100 may serve as the basis for a multi-service network based on connection-oriented packet switching. Alternative embodiments may be based on wireless networks or coaxial cable networks.

Access networks may connect customers to an interoffice network and carry customer traffic to and from the network. From an interoffice network perspective, access networks may be viewed as data sources and sinks. Since the early days of telephone networks, access has been provided by running twisted pairs of copper wire from the customer premises to the COs supporting subscriber connections, which are referred to as serving wire centers (SWCs). Even today most access lines are twisted pairs. The capacity of twisted pair access line has been greatly enhanced through the use of digital subscriber line (DSL) techniques. Subscribers can also access the network via coaxial cable, or fiber optic lines, or by wireless, commonly radio, links.

Typically, network nodes may be interconnected by fiber optic cables which can support very high data rates via a hierarchy of data channels. Different fibers within a cable separate signals spatially and may be viewed as space channels. Multiple signals at different wavelengths may be transported within a fiber so that each space channel may be viewed as containing multiple wavelength channels. Similarly, the signals at each wavelength can be divided into multiple repetitive time intervals, which may be viewed as time slot channels.

The Synchronous Optical Network (SONET) and the Synchronous Digital Hierarchy (SDH) standards define frame structures and data rates for the time-slotted signals used in an embodiment of the network. SONET/SDH frames have a repetition interval of 125 microseconds and data rates that are multiples of 51.84 Mb/s, the fundamental SONET data rate. The fundamental SONET frame, the Synchronous Transport Signal (STS-1), has a payload that contains approximately 800 bytes and supports a data rate of approximately 50 Mb/s. Each byte within the payload can be viewed as corresponding to a digital signal level 0 channel, referred to as DS0. This may support a data rate of 64 Kb/s. Higher order SONET frames may be formed by byte interleaving of fundamental frames. For example, STS-3 frame, which is equivalent to the fundamental SDH frame, may be formed by byte interleaving of three STS-1 frames. Higher order SONET/SDH frames are equivalent to a large number of DS0 time slots.

### Network Operation Based on Connection-Oriented Packet Switching

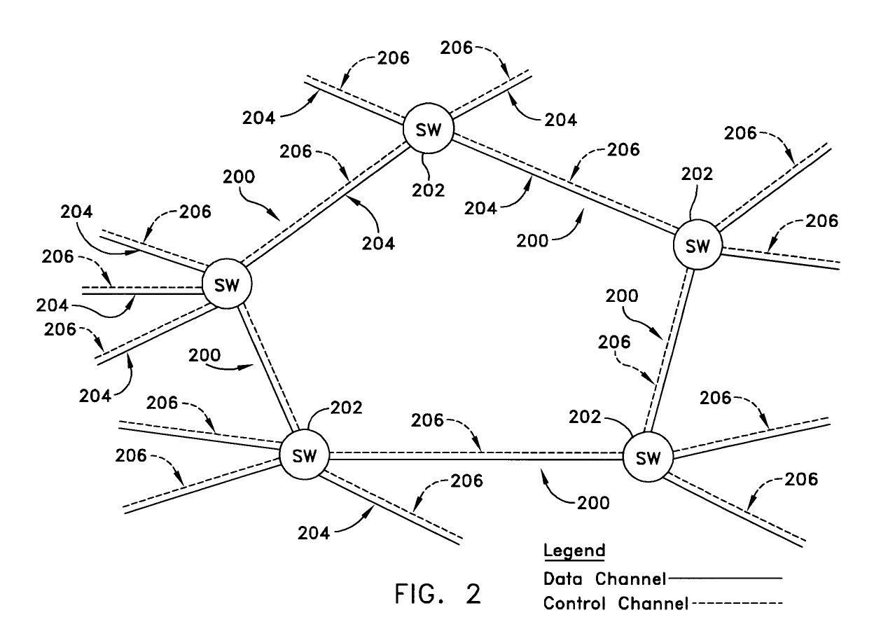

Referring to FIG. 2, there is shown an interconnection 200 of multiple switching elements 202 within a network, such as network 100 (FIG. 1). This forms a connection-oriented packet switching network. Each switching element 202, i.e., node 202, may be connected by transmission lines to two or more other nodes 202. Solid lines 204 indicate connections carrying data, while dotted lines 205 indicate connections carrying control signals. Control signals and data may flow through the same transmission lines 204/206, which may be fiber optic cables. However, control signals may be assigned channels that are separate from data channels. All these connections may be full duplex, i.e., carrying data/signals in both directions. However, the capacities of the channels assigned to the two directions may be different. Network nodes may also be connected to nodes outside the network, specifically end-user nodes. Data and control signals from these external nodes would also be carried in separate channels.

Control signals are used to establish physical and virtual connections. These include end-to-end connections between users, connections between end users and the network, and connections between network elements. Typically, a physical connection would support multiple virtual connections.

Network users include clients, the consumers of communication services, and servers, the providers of communication services. Although clients can communicate with clients and servers with servers, most of the communications is assumed to be between clients and servers, and most of the data is assumed to flow downstream from servers to clients. Although clients can communicate with clients and servers with servers, most of the communications may generally be between clients and servers, and most of the data may generally flow downstream from servers to clients.

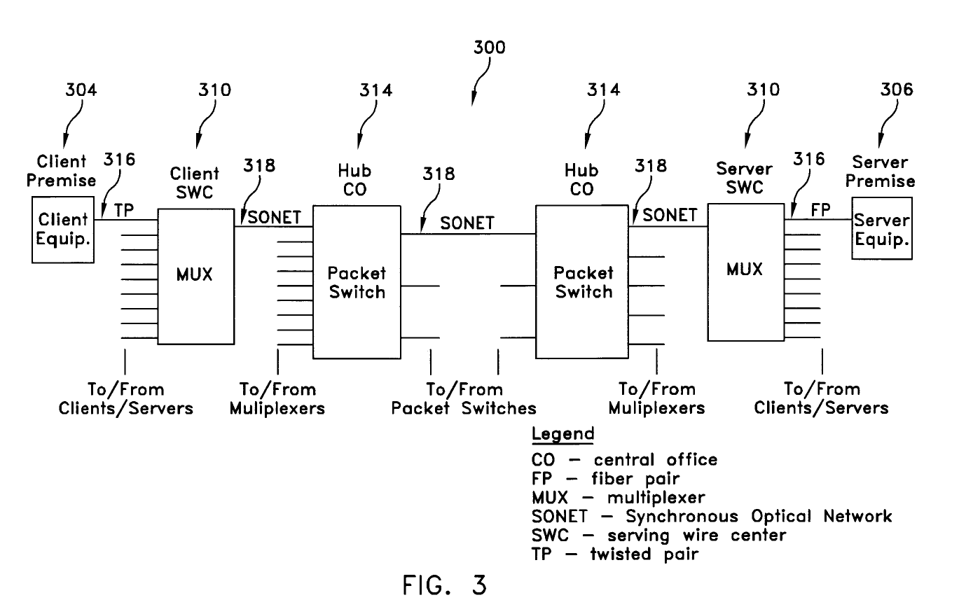

FIG. 3 illustrates the operation of a network 300 with key elements involved in the supporting communications between a client and a server, such as those within network 200 (FIG. 2). Network 300 may include equipment 302 at the premises of a client 304 and of a server 306, multiplexers 308 at the central offices 310, directly connected to clients 304 and to servers 306, which are referred to as serving wire centers (SWCs); and packet switches 312 at hub COs 314. Typically, a hub CO 314 generally also acts as a SWC 310, or in other words, a subset of SWCs 310 may also act as hubs 314. In the case illustrated by FIG. 3, the virtual connection traverses only two packet switches. Connections over a larger area may involve additional packet switches 314.

With the approach shown in FIG. 3, only the relatively short access lines 316 from the customer premise to SWCs 310 may be dedicated while interoffice lines 310 are shared. This makes the approach of FIG. 3 cost-effective. Full blown packet switches 312 rather multiplexers 310 may be provided at all the COs 310, 314 rather than only at hub COs 314. This reduces the need to backhaul all the traffic to hubs 310, 314 and would allow the capacity of the connections between packet switches 312 to be reduced. However, this configuration requires more complex and more expensive network elements at SWCs 304.

Traffic from multiple users 304 is multiplexed at SWC 310 and sent on to label switch 312 over a common physical connection. Similarly, traffic from packet switch 312 is demultiplexed at SWC 310 and sent to users over separate access lines. FIG. 3 shows a twisted pair access line 316 for client 304 and a fiber access line 316 for server 306. Generally, servers 306 operate at relatively high data rates, which may require fiber, while clients 304 may be satisfied with data rates that can be provided over twisted pairs using digital subscriber line (DSL) techniques.

Multi-Protocol Label Switching (MPLS) is a connection-oriented technique that may be used to provide guaranteed quality of service for IP traffic (and other types of traffic). With the IP/MPLS approach, virtual connections called label switched paths (LSPs) are established, and labels are attached to IP packets to identify particular LSPs. Forwarding of a packet is based on the 20 bit label in the MPLS header rather than on the 32 bit IP address (for IP version 4) in the IP header, which makes forwarding easier to implement. With MPLS, network capacity can be reserved along the LSP so that the quality of service for a traffic flow can be guaranteed.

A consensus is forming around IP data and MPLS transport. Thus, the preferred embodiment of the integrated network is based on IP and MPLS. Data associated with various applications, including voice and video, would be encapsulated in IP packets. LSPs would be established, and MPLS headers would be attached to IP packets and used to transport data along LSPs.

Control signaling for establishing and managing physical and virtual connections may be based on Generalized MPLS (GMPLS) standards. The network elements (or sub-elements) involved with control signaling and the set of network channels containing the control signals are collectively referred to as the control plane, specifically for the preferred embodiment, the GMPLS control plane.

MPLS labels can be stacked, and multiple LSPs can be nested in a higher level LSP. The signaling protocols can be used to control the network capacity assigned to an LSP containing multiple virtual connections. This gets us back to common channel signaling, with the control signaling separate from the data transport and with a signaling connection able to control multiple data connections, in this case virtual connections.

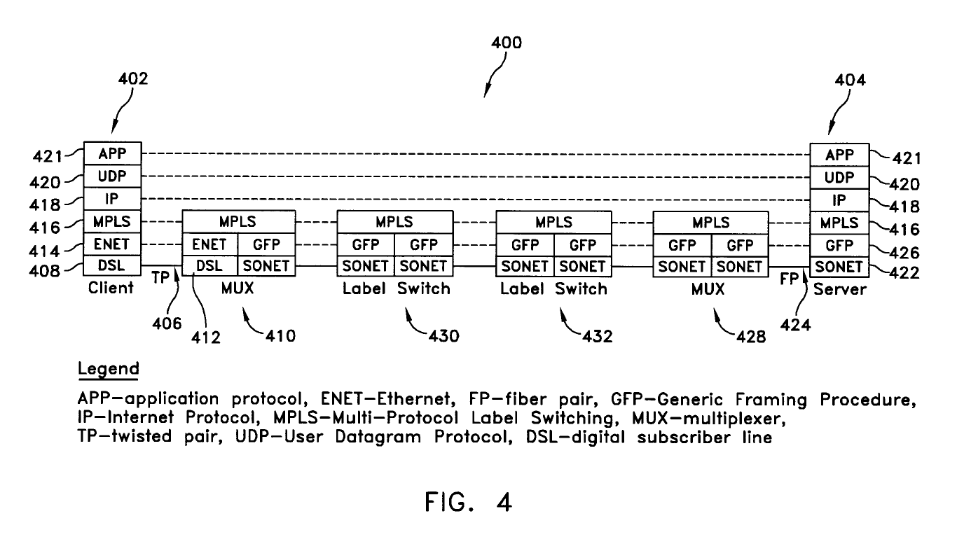

FIG. 4 shows an embodiment of the communication protocols employed in transporting data between a client 402 and a server 404. Other sets of protocols could be employed instead.

As shown in FIG. 4, client premises 402 would typically be connected to the telephone network by a twisted pair access line 406 with a DSL physical layer interface 408. A layer 2 protocol (L2P), such as Ethernet, may be employed between customer premise 402 and a multiplexer 410 (MUX), in this case a DSL access multiplexer 412 (DSLAM), in telephone central office 410 (CO). Ethernet is the protocol of choice for many network customers. However, other layer 2 protocols may be employed. MPLS 416, which may run on top of the layer 2 protocol, supports LSPs and virtual connections. IP 418, the User Datagram Protocol 420 (UDP), and the application protocol run on top of MPLS. UDP 420 is appropriate for applications involving continuous data flows (streaming applications). For bursty applications, such as file transfers, TCP may be used instead of UDP.

At server premises 404, a physical layer interface 422 may be SONET over fiber 424 to multilplexer 428. The Generic Framing Procedure (GFP) 426 provides layer 2 functions associated with packet framing, i.e., determining where packets begin and end. MPLS 416 supports the end-to-end virtual connections with multiple clients. Again, IP 418, UDP 420, and the application protocol 421 run over MPLS 416.

Multiplexer 410 may statistically multiplex and demultiplex IP data from and to multiple users 402. Multiplexers 410 may operate at layer 2 of the OSI model, using Ethernet 414 or some other layer 2 protocol. Routers 430 and 432 may operate at the MPLS layer, which can be viewed as lying between layers 2 and 3. Labeled packets may be forwarded without reading the IP header. To accommodate legacy equipment and networks, router 428/430 needs to be able to accommodate unlabeled packets. If the MPLS label is missing, router 428/43 processes the packet using current IP transport procedures.

For labeled packets, IP 418 runs on top of MPLS 416 and is not used by the network. Similarly, TCP and the application protocol run on top of IP 418. For streaming applications, the User Datagram Protocol 420 (UDP) would normally be used instead of TCP.

The protocols of FIG. 4 are employed in the data channel primarily to support the transfer of data between client 402 and server 404. A different set of protocols may be used in the control plane and its associated signaling channels to support the establishment and management of virtual connections and reservation of capacity for these connections. The Label Distribution Protocol (LDP) and/or the Resource Reservation Protocol (RSVP) are employed in conjunction with the GMPLS control plane to establish LSPs and reserve network capacity along these LSPs. The Internet Engineering Task Force (IETF) is developing a new extensible IP signaling protocol suite (NSIS), which may provide additional capabilities and more flexibility in establishing and controlling virtual connections.

Where applicable, the signaling protocols listed above may be used to support a guaranteed quality of service. However, these protocols are exemplary, and are not intended to be limiting. Generally, control signaling functions are needed, which are not included in these protocols. Thus, extensions of these protocols or additional signaling are required. The real the issue is not which protocols are used, but how signaling is used in conjunction with label switching to enable a quality of service comparable to quality of service provided by circuit switching.

### Embodiments of a Switching Element

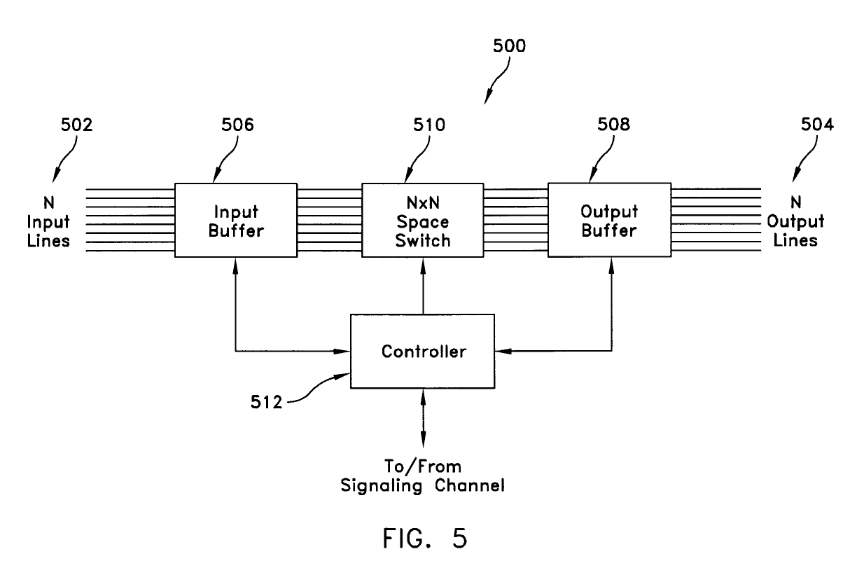

The heart of network 100 (described above) is a generic switch 500, which is illustrated by FIG. 5. Generic switch 500 is a common network element that supports both circuit switching and packet switching. Generic switch 500 is an embodiment of packet switch 400 described in the previous section.

Signals are switched in both space and time. Each of the input lines (or space channels) is broken up into time intervals (or time channels). If an input signal contains multiple carrier frequencies or wavelengths, the signal would be converted to signals on multiple lines prior to switching. Thus, a single fiber containing multiple channels may be equivalent to multiple fibers each containing a single wavelength channel. The generic switch maps space-time channels at its input onto space time channels at its output.

Generic switch 500 in FIG. 5 is connected to N network elements with an input line 502 and an output line 504 for each of these N elements. Data on the N input lines 502 are switched onto the N output lines 504. Multiplexers 410/428 (FIG. 4) may be viewed as simplified versions of labels switches. With these multiplexers, N input lines 502 are switched onto a single output line 504, and a single input line 502 is demultiplexed onto N output lines 504.

Switch 500 of FIG. 5 contains an input buffer 506, an output buffer 508, a space switch 510, and a controller 512. The input buffer receives data on each of the N input lines 502 (e.g., space cells) and stores this data, in some case for only a very short period of time. Data on these lines are contained in time slots (e.g., time cells) associated with particular LSPs. Output buffer 508 stores data for each of the output lines 504 and transmits data over each of the output lines at the appropriate time. Space switch 510 connects input buffer 506 to output buffer 508. It switches data received from each of input lines 502 to storage elements in output buffer 508 connected to each of output lines 509. In a straightforward implementation, space switch 510 is an N by N crossbar matrix, so that each of its N input lines 502 may be connected to each of its N output lines 504. Data may be switched for every time slot so that data from a particular input line may be transmitted over a different output line for every time slot. The primary function of controller 512 is to generate the switching matrix relating the switch input to the switch output for every time slot. As described below, controller 512 uses signaling information from the control pane and labels attached packets to generate the switching matrix.

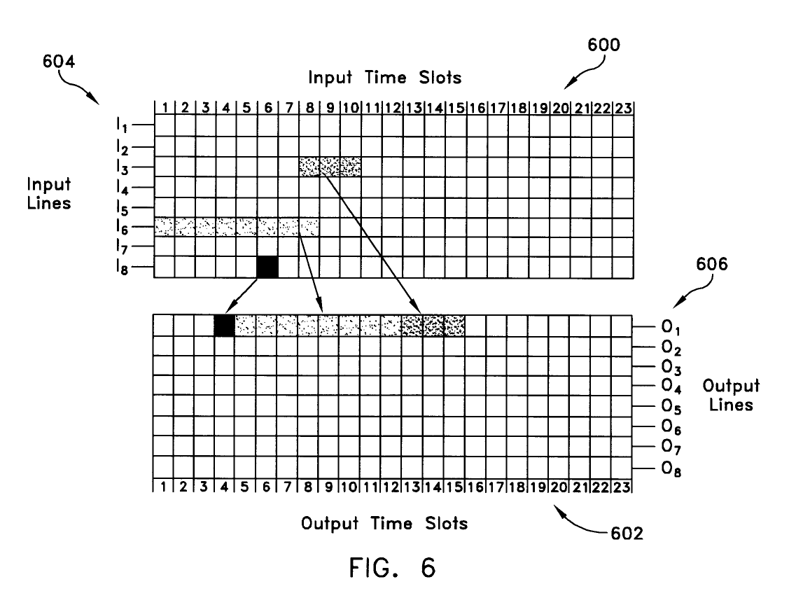

FIG. 6 illustrates an exemplary embodiment of the operation of generic switch 500 (FIG. 5) having 23 input time slots 600 and 23 output time slots 602 for 8 input lines 604 and 8 output lines 606. In this case, there are 23 time slots, which corresponds to the situation with primary rate ISDN. An embodiment may involve SONET/SDH rather than ISDN. However, the ISDN case is simpler and easier to illustrate.

Each ISDN time slot contains one byte of data. The ISDN frame containing the time slots is repeated 8000 per second. The generic switch maps time-space cells at input 600 onto time-space cells at output 602. The switching matrix contains 8 times 23 elements, with each element identifying the output line that is the destination of the data contained in a particular time slot on a particular input line. The FIG. 6 illustrates the mapping of time slots on the input lines to time slots on the output lines. Interchanging of time slots may be performed in both input buffer and the output buffer. Thus generic switch 500 (FIG. 5) may be viewed as a time-space-time switch, i.e., a switch that performs time switching, space switching, and time switching, in that order.

Data on each of the N input lines 604 of (FIG. 6) may be stored for a short time interval in the input buffer. Data may be read out of the input buffer in an order different from the order in which it was read in, which allows time slots to be interchanged. Data is switched from the input lines to the output lines of the N by N space switch, with the space switching pattern possibly changing from time slot to time slot. Data exiting the space switch is stored in the output buffer while it is waiting to be placed on an output line. In reading out the data, the output buffer can perform a second interchange of time slots. Thus, the switch employs three stages of switching, time switching, space switching and time switching again. With this arrangement of switching elements, blocking within the switch can be eliminated. Thus, data in any time slot on any input line can be placed in any time slot on any output line. Of course, there would be a conflict if the switch attempted to map data from two or more inputs onto the same space-time channel at the output.

With circuit switching operation, the time slot interchange and space switching functions within the generic switch may be controlled via the control plane based on information provided in the signaling channels. The controller may monitor the signaling channels and may determine the switching pattern for mapping input space-time channels onto output space-time channels. This pattern may include time slot interchange parameters for all input and output lines and space switching parameters for all time slots. The time slots may be viewed as implicit labels that identify particular data flows associated with the data within the time slots. With circuit switching, the switching pattern is predetermined for each connection through the switch. The switching pattern is modified whenever a connection is established or released or when the number of channels assigned to a connection is varied. The controller would send updated interchange and switching parameters to the buffers and the space switch, respectively, whenever the switching pattern is modified. This modification of the switching pattern may be viewed as dynamically changing the implicit labels associated with the time slots.

Packet switching operation of the generic switch may be similar, but is generally more complex. As with circuit switching operation, time slot interchange and space switching patterns are determined by the controller. Unlike the circuit switching case, the switching pattern is not predetermined for packet switching operation. Instead the switching pattern must be determined on-the-fly based on explicit labels contained in the packet headers. The controller must read the header of each packet entering the switch. If the header indicates that the packet is part of an existing data flow, the routing through the network is generally already determined and the output line is generally available in an existing table. Otherwise, the routing of the packet will have to be determined by the routing algorithm, which may involve the exchange of control messages with other switches. Once the output line for the packet is determined, the controller must determine when the packet should be read out of the input and output buffers. Also, the packet header may need to be modified as the packet passes through the switch. The on-the-fly processing described above make the latency and throughput requirements on the controller considerably more stringent for packet switching compared to the corresponding requirements for circuit switching.

### Achieving a Guaranteed Quality of Service

With circuit switching, network capacity is dedicated to a particular connection and the quality of service (QoS) can be guaranteed. With connection-oriented packet switching, it is possible to provide a guaranteed QoS for a particular data flow, by reserving a sufficient amount of network capacity for the virtual connections supporting the particular data flow. This is sometimes referred to as circuit emulation. One issue is how to ensure that sufficient capacity is allocated to particular data without wasting network capacity.

Ensuring a guaranteed QoS is closely tied to control signaling. For the embodiment of the network previously described, the operation that would provide a guaranteed QoS for a particular data flow may proceed as follows.

End-to-end virtual connections (LSPs) may be established between the end users with at least one LSP for the data flow in each direction.

The data flow may be monitored at its source to determine the data rate and to estimate changes in the data rate before they occur. The source may request that sufficient capacity to accommodate the required data rate be assigned to an LSP in advance of when the capacity is required. The network may allocate capacity in advance along the LSP for a certain time interval such that this capacity may be sufficient to accommodate the data flow. The time interval may be adjusted based on the latency, e.g. delay, of the application associated with the data flow. Capacity may be requested and allocated only as required to accommodate the actual data flow.

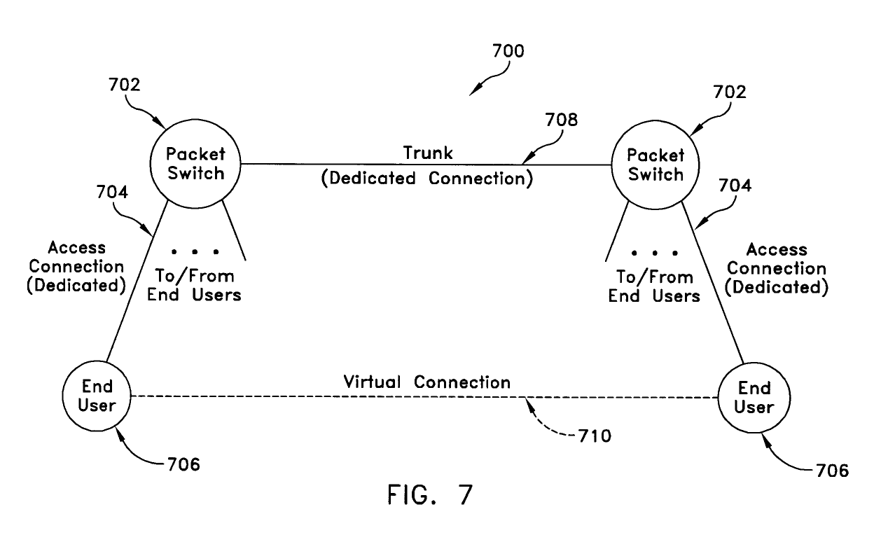

A simplified packet switching network 700 shown in FIG. 7 provides an illustration of the operation described above. Network 700 of FIG. 7, which may be formed from the network of FIG. 1, contains only two packet switches 702 and dedicated (circuit switched) connections 704 between two end-user nodes 706 and the packet switching elements 702. There are multiple users connected to each packet switch 702 (via dedicated and/or virtual connections). Two packet switches 702 in FIG. 7 are connected to each other by a dedicated (circuit switched) connection 708 with a fixed capacity. Dedicated connection 708 between packet switches 702 may support multiple virtual connections. Although not shown in FIG. 7, a packet switch would typically be connected (either directly or indirectly) to multiple other packet switching elements 702. An end-to-end virtual connection 710 may be established between the two end-user nodes. This virtual connection runs through the network and through the two packet switches.

For the network of FIG. 7, the primary QoS issue involves trunk 708 interconnecting two packet switches 702. The end user would request that a certain amount of network capacity, in this case capacity on trunk 708, be allocated to a particular LSP over a certain time interval. The requested capacity would be greater than or equal to the amount of data generated by the source over the time interval and the request would be sent in advance of the time interval. If sufficient trunk capacity is available, it would be allocated by the network to the particular LSP.

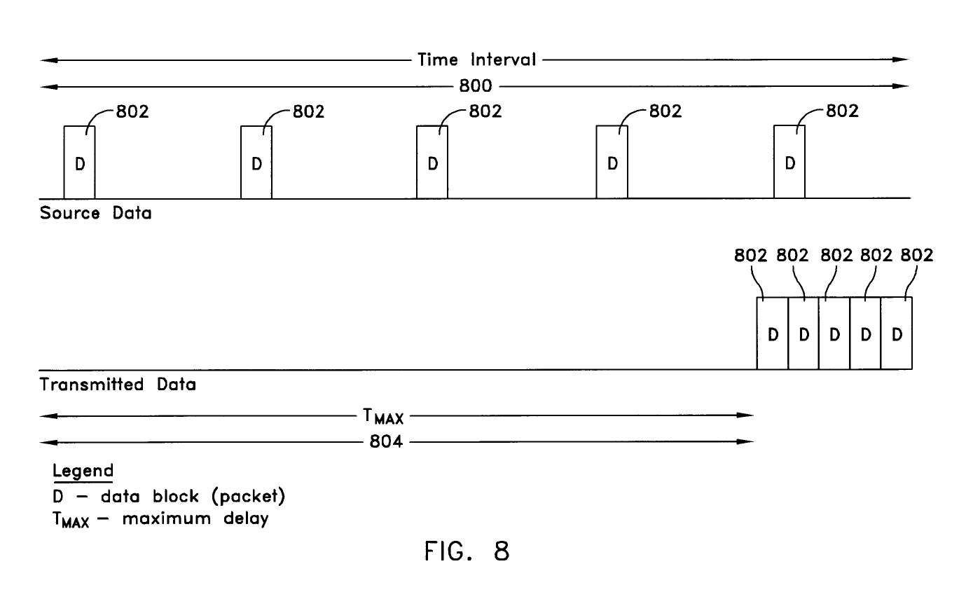

Allocating a capacity sufficient to accommodate the total amount of data generated by the source over the time interval ensures that all the data from the particular source can be transferred within the time interval. It also ensures that the maximum delay is less than the time interval. This situation illustrated by FIG. 8. During a time interval 800, the source generates an amount of data represented by the five data blocks 802 (e.g., 5D). If sufficient trunk capacity is allocated, a maximum delay 804 will occur if the five data blocks 802 are sent over the trunk at the end of the time interval. Assuming propagation delays and other fixed delays are negligible, maximum delay 804 for a data block 802 would be less than the time interval. The time interval may be varied to meet the latency requirements of the application. The rate of the data source may vary from one time interval to the next. Thus, the requested and allocated capacity would also vary. This would prevent capacity from being tied up unnecessarily for long periods of time, as is the case with static circuit switching.

The situation would be more complex if the data traverses more than two packet switching elements. However, the basic concept remains the same. For a more complex network with multiple packet switching elements, each packet switching element along the LSP may act as a data source and may request that capacity be allocated for the link to the next packet switch along the LSP. Sufficient network capacity may need to be provided along all the links of the LSP. For successive links along the LSP, the time interval would need to be offset by some small amount to allow for the link propagation delays and fixed delays through the packet switching elements. Thus, the maximum delay could be greater than the time interval. However in most cases, a guaranteed QoS may be supported for a packet switching network with multiple packet switching elements if the time interval is small enough and if sufficient capacity is allocated along the LSP.

In summary, the approach described above involves allocating to a particular traffic flow a certain amount of network capacity over a certain time interval. This allows a guaranteed quality of services to be provided for the particular traffic flow and distinguishes this invention from the prior art.

### Suppression of IP Headers

IP global addresses cause vulnerabilities that can be exploited by certain threats.

Even if the data is encrypted, an intruder may determine traffic patterns and may direct certain attacks against particular sites. Encryption of IP headers may counteract these threats, but complicate transport and may limit interoperability.

If switching/forwarding is based on MPLS labels rather IP addresses, IP headers become superfluous for transport though the network. Thus, for labeled packets, the IP headers (and possibly TCP and UDP headers) may be stripped off at the sending end and re-inserted at the receiving end. Note that an MPLS header identifies an LSP, which in turn can be associated with the route traversed the packets, including the source and destination of the packets.

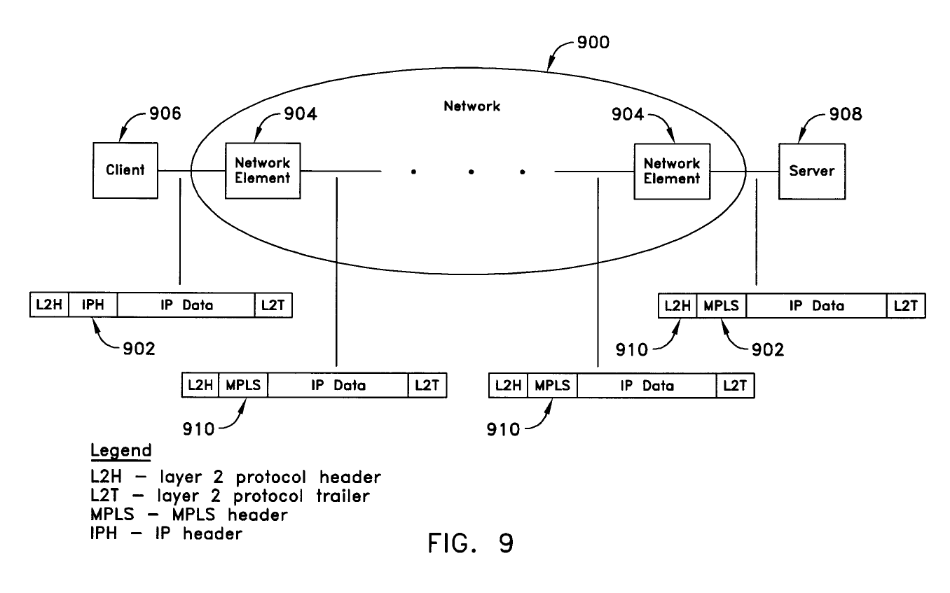

FIG. 9 illustrates a network 900 with the removal and re-insertion of IP headers 902 in the networks element 904 directly connected to a client 906 and a server 908. In the case shown, MPLS protocol 910 is implemented by the server but not by the client. Note that network elements in FIG. 9 could be located at the premises of client equipment 906 and/or server 908. Note also that IP headers 902 may also be removed (and re-inserted) in end-user equipment, e.g. client 906.

For unlabeled packets, IP headers 902 may be used in the label switches, and possibly the multiplexers, to determine where to route the packets. Thus, IP headers 902 need to be retained for unlabeled packets. Also, IP headers 902 need to be re-inserted as the data enters a network segment that does not have MPLS capabilities. Re-insertion of the IP headers as the packets leave the network (or network segment) allows the network to maintain compatibility with user equipment and legacy networks.

Removing IP headers 902 (and other headers) may reduce the overhead and improve transport efficiency, which is significant for voice applications over low capacity access lines.

Security could be enhanced by suppressing IP headers 902. MPLS headers 910 have only local significance. If the control channels are secure, then an intruder would not be able determine the source and destination of a packet from MPLS headers 910. Thus, stripping IP headers 902 prevents an intruder from performing a traffic analysis and complicates a denial-of-service attack. Removal of IP headers 902 may enhance security even if the data is not encrypted. However, for sensitive data that needs protection, end-to-end encryption should be employed.

Security must be provided for the control plane so that connections can be securely established and channel capacity can be securely allocated. Controls signals between network elements and between users and network elements may be encrypted using IPSec or other well established techniques. Also, network elements may police user requests to guard against improper requests for connections or network capacity. It is easier to provide security for the control plane than for end-to-end data flows. Data rates are generally much lower for the control plane, and latency requirements are less stringent. This implies that optimizing control plane traffic flows is less important than optimizing end-to-end data flows between users.

The suppression of IP headers 902 to achieve greater transport efficiency and enhanced security clearly distinguishes this invention from the prior art.

I claim:

1. A wide-area multi-service communication network, comprising:
multiple switching elements capable of switching data from input channels to output channels in response to control signals, the data encapsulated in Internet Protocol (IP) packets at a source;
transmission lines with multiple channels interconnecting each of the multiple switching elements to at least one of the other switching elements;
access lines with multiple channels connecting the switching elements to network users;
control channels configured to carry control signals through the network, the control signals configured to dynamically set up virtual connections through the network and allocate network resources to the virtual connections, the control signals configured to attach labels to the IP packets to identify the virtual connections associated with these packets, and the switching elements configured to use the labels to transport data through the network; and
network capacities configurable for allocation to particular virtual connections for periods of time, the capacities configured for allocation to particular dynamically varied virtual connections based on needs of the virtual connections, and the capacities configured for allocation in advance of the needs of the virtual connections so as to accommodate varying rates of the data.

2. A wide-area multi-service network in accordance with claim 1, wherein the virtual connections are configured for transport based on label switching with a selected quality of service and delays reduced below a maximum delay.

3. A wide-area multi-service network in accordance with claim 1, wherein the network and elements of the network are configured to operate simultaneously in both circuit switching and packet switching modes, wherein operation in the circuit switching mode is configured to use implicit labels associated with time slots containing the data to be switched, and wherein transport in the packet switching mode is configured to use explicit labels contained in headers of the packets.

4. A wide-area multi-service network in accordance with claim 1, wherein the network is configured to transport the data in the IP packets via label switching based on Multi-Protocol Label Switching (MPLS) standards.

5. A wide-area multi-service network in accordance with claim 1, wherein the control signaling is based on Generalized Multi-Protocol Label Switching (GMPLS) standards, and wherein the virtual connections set up by the control signals correspond to MPLS label switched paths.

6. A wide-area multi-service network in accordance with claim 1, wherein the switching elements are configured to forward unlabeled packets in a manner as generally performed by conventional IP routers.

7. A wide-area multi-service network, comprising:
multiple switching elements capable of switching data from input channels to output channels in response to control signals, the data encapsulated in Internet Protocol (IP) packets at a source;
transmission lines with multiple channels interconnecting each of the multiple switching elements to at least one other switching elements;
access lines with multiple channels connecting the switching elements to network users; and
control channels configured to carry control signals through the network, the control signals configured to dynamically set up virtual connections through the network and allocate network resources to the virtual connections, labels configured for attachment to the IP packets so as to identify the virtual connections associated with these packets, the switching elements configured to use the labels to transport the data through the network, and the network configured to remove the IP headers upon entry into the network, for at least a subset of the data transported through the network and to re-inserted as the IP packets upon exit of one of the network and a segment of the network.

8. A wide-area multi-service network in accordance with claim 7, wherein control signals are encrypted to prevent exploitation by intruders, and wherein labels have only local significance and cannot be used by intruders to determine the source and destination of data within virtual connections.

9. A wide-area multi-service network in accordance with claim 7, wherein the packets are transported through the network via label switching based on Multi-Protocol Label Switching (MPLS) standards.

10. A wide-area multi-service network in accordance with claim 7, wherein the control signaling is based on Generalized Multi-Protocol Label Switching (GMPLS) standards, and wherein the virtual connections set up by the control signals correspond to MPLS label switched paths.

11. A wide-area multi-service network in accordance with claim 7, wherein the network is configured to retain IP headers for unlabeled packets, and wherein the switching elements are configured to forward unlabeled packets in a manner corresponding to the forwarding performed by conventional IP routers.
